(19) United States
(12) Patent Application Publication
(10) Pub. No.: US 2004/0203290 A1
(43) Pub. Date: Oct. 14, 2004

(54) Connector structure

(76) Inventors: Ya-Mei Wang, Shu Lin City (TW); Wan-Ju Kao, Shu Lin City (TW)

Correspondence Address: CHARLES E. BAXLEY, ESQUIRE, Fifth Floor, 59 John Street, New York, NY, 10038, US

(21) Appl. No.: 10/413,477

(22) Filed: Apr. 14, 2003

(51) Int. Cl. H01R 13/648

(52) U.S. Cl. 439/608

(57) ABSTRACT

A thin connector structure, at one end of which is provided with an inserting slot and at another end of which is formed with a connecting end, in the inserting slot is provided with a plurality of connecting terminals that extend to the connecting end. Furthermore, at both ends of the connector structure two ground terminals are disposed at both sides of the connector respectively, the inserting slot serves for insertion of the buses. The connector structure can be embedded in the circuit board in an offset manner or just by laying thereon.

### BACKGROUND OF THE INVENTION

1. Field of the Invention

The present invention relates a thin connector structure, and more particularly to a connector structure which can be set on the circuit board either in an offset manner or just by laying thereon.

2. Description of the Prior Arts

With the development of the science and technology, the electronic products are becoming smaller and more ingenious than ever, that's why the same are so popular, such as the note book, personal digital assistant (PDA), mobile phone and the like are characterized as small volume and ingenious design. While the connector is an indispensable component of the above-mentioned products that generally serve as connection between the liquid crystal display (LCD) and the circuit board.

Normally a conventional connector comprises a male and a female portion, while the connector can be welded into the circuit board either in an offset manner or just by laying thereon (normally by welding the female portion into the circuit board). The offset manner means welding the female portion into a notch of the circuit board. While the connector of the off-set manner is provided with a notch for receiving the female portion therein such that the circuit board will not be thickened after the receipt of the female portion of the connector. However, the conventional connectors of the offset manner and laying-thereon one are differently constructed, in other words, the structures of the connectors vary from different setting manner with respective to the circuit board, thereby the setting manners of the connectors of same structure will be limited, so is the applicability of it.

The present invention has arisen to mitigate and/or obviate the afore-described disadvantages of the conventional connector.

### SUMMARY OF THE INVENTION

In accordance with one aspect of the present invention, there is provided a thin connector structure, which is provided with an inserting slot at one end and a connecting end at the other, in the inserting slot a plurality of connecting terminals are disposed in a manner of extending to the connecting end, furthermore, at the ends of the both sides a ground terminal is disposed respectively.

The primary objective of the present invention is to provide a connector structure, which can be set on circuit board either in an offset manner or just by laying thereon.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a perspective view of a connector in accordance with the present invention;

FIG. 2 is a cross sectional view of the connector of the present invention being set on the circuit board in a laying-thereon manner;

FIG. 3 is another cross sectional view of the connector of the present invention being set on the circuit board in a laying-thereon manner;

FIG. 4 is a cross sectional view of the connector of the present invention being set on the circuit in an offset manner;

FIG. 5 is another cross sectional view of the connector of the present invention being set on the circuit in an offset manner.

### DETAILED DESCRIPTION OF THE PREFERRED EMBODIMENT

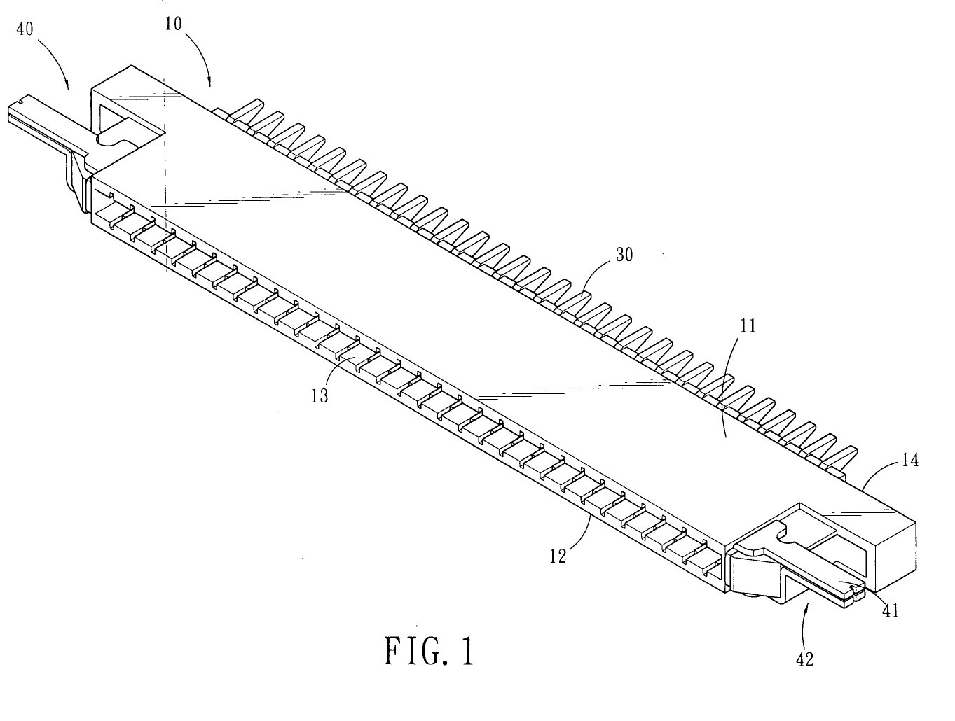

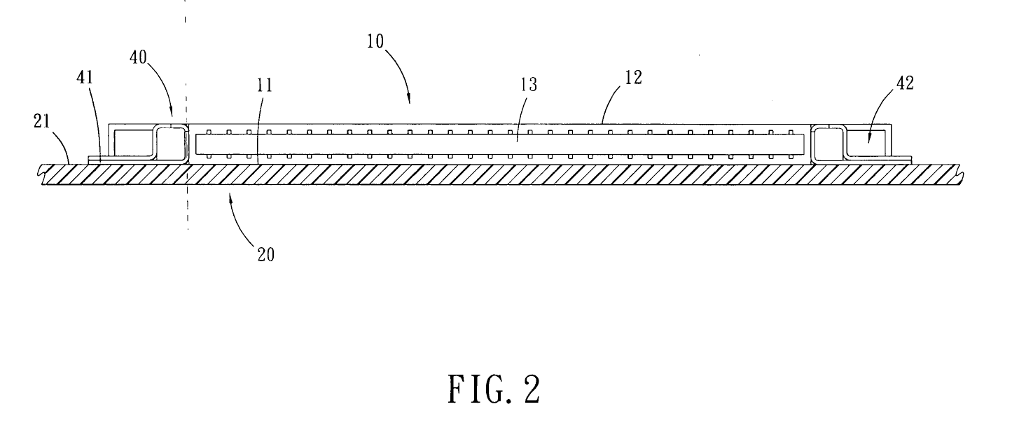

Referring to FIGS. 1-2, wherein a thin connector structure 10 in accordance with the present invention is shown and generally has a first panel 11 and second panel 12. The first panel 11 and the second panel 12 is opposite with each other. The first panel 11 and the second panel 12 are corresponding to a circuit board 20 respectively. The connector 10 is provided with an inserting slot 13 at one end and a connecting end 14 at the other, in the inserting slot 13 a plurality of connecting terminals 30 are disposed and extending to the connecting end 14. Moreover, two ground terminals 40 are disposed at the ends of both sides respectively. By such a manner, the connector 10 may be connected with the circuit board 20 via the ground terminals 40 together with the connecting terminals 30, while the inserting slot 13 serves for insertion of buses in small volume. It will be noted that the characters of the present invention lie in:

Each of the ground terminals 40 is L-shape constructed in cross section including a connecting surface 41 and a gap 42, wherein the connecting surface 41 is a side of the L-shaped ground terminal 40 and flush with the first panel 11 of the connector 10. While two sides of the ground terminal 40 define the gap 42, which facing towards the second panel 12 of the connector 10.

The connecting terminals 30 extending to the connecting end 14 of the connector 10 are flush with the first panel 11 of the same while certain distance apart from the second panel 12.

By such arrangement, the connector 10 may be coupled to the circuit board 20 either in manner of offset or just by laying thereon.

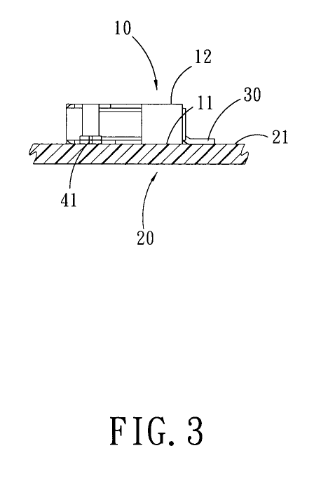

Referring now to FIGS. 2-5, first the connector 10 is welded into the circuit board 20 just in manner of laying thereon (as shown in FIGS. 2-3), wherein the connector 10 lies on the circuit board 20 directly (namely the second panel 12 of the connector 10 and the welding surface 21 of the circuit board 20 are identically directed). Due to the connecting surface 41 of the ground terminal 40 is flush with the first panel 11 of the connector 10, and the connecting terminals 30 are alike flush with the same, the connecting surface 41 together with the respective connecting terminals 30 are permitted to snugly abut against the welding surface 21 of the circuit board 20 which is feasible for the welding operation.

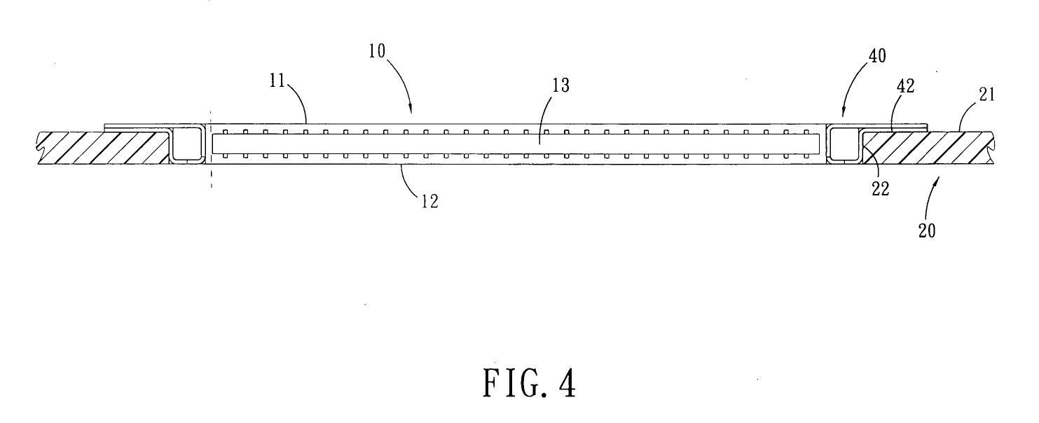

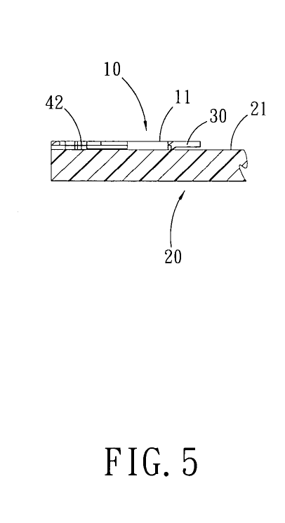

Second, the connector 10 is welded into the circuit board 20 in an off-set manner (as shown in FIGS. 4-5), wherein a chamber 22 is defined at the periphery of the circuit board 20 for receipt of the connector 10 (namely the first panel 11 of the connector 10 and the welding surface 21 of the circuit board 20 are identically directed), the connector 10 is embedded therein with two sides of the chamber 22 of the circuit board 20 locating in the gap 42 of the ground terminals 40 respectively. Such that the ground terminal 40 is flush with the welding surface 21 of the circuit board 20, so is the connecting surface 41. While the connecting terminals 30 is flush with the same along with connecting surface 41 such that will be feasible for welding operation.

It is concluded from above descriptions that the structure of the connector of the present invention will not be varied with the manners of which being setting on the circuit board, and the connector possesses a better applicability, whereby to save the production cost, especially the advantages can be better shown in mass production.

While we have shown and described various embodiments in accordance with the present invention, it should be clear to those skilled in the art that further embodiment may be made without departing from the scope of the present invention.

1. A connector structure which not only can be flatly laid on a circuit board but also can be embedded in the circuit board in an offset manner, which comprising a first panel and a second panel with corresponding to the circuit board respectively, at a lateral side of the connector structure being provided with an inserting slot and at another lateral side of the connector structure being provided with a connecting end, in the inserting slot a plurality of connecting terminals being disposed and extended to the connecting end, at both ends of the connector structure two ground terminals being disposed respectively, the connector structure can be connected with the circuit board via the ground terminals together with the connecting terminals, while the inserting slot serving for insertion of buses, wherein:
each of the ground terminals includes a connecting surface and a gap, wherein the connecting surface is flush with the first panel of the connector structure, the gap faces towards the second panel of the connector structure, the connecting terminals are flush with the first panel of the connector structure while a certain distance apart from the second panel (the connecting terminals and the second panel of the connector structure do not lie in the same plane), in a flat manner the connector structure can be flatly laid on the circuit board, such that the connecting surfaces of the ground terminals and connecting terminals are allowed to flatly against and connect with the circuit board, the connector structure further can be embedded in the circuit board in an offset manner since the gaps of the ground terminals and the connecting terminals enable the connector structure to straddle and connect with the circuit board, such that the connector structure will be flush with the top surface of the circuit board, the connector is feasible for setting on the circuit board.
